(19) United States
(12) Patent Application Publication
(10) Pub. No.: US 2022/0180055 A1
(43) Pub. Date: Jun. 9, 2022

(54) PRIORITIZING AND RECOMMENDING SOCIAL MEDIA INTERACTIONS

(71) Applicant: International Business Machines Corporation, Armonk, NY (US)

(72) Inventors: Olivia Gulsvig, Davis, CA (US); Stefan A.G. Van Der Stockt, Austin, TX (US)

(21) Appl. No.: 17/116,284

(22) Filed: Dec. 9, 2020

(51) Int. Cl. G06F 40/20; G06Q 50/00

(52) U.S. Cl. CPC G06F 40/20; G06Q 50/01

(57) ABSTRACT

Embodiments herein disclose computer-implemented methods, computer program products and computer systems for prioritizing and recommending social media interactions. The computer-implemented method may include one or more processors configured for obtaining first profile data corresponding to a first social media account and additional profile data corresponding to additional social media accounts; determining a first unique identifier based on the first profile data and additional unique identifiers based on each respective additional profile data; determining overlap scores between the first unique identifier and each of the additional unique identifiers; prioritizing the additional social media accounts based on a first order of priority; and displaying the additional social media accounts based on the first order of priority on a user interface of a computing device associated with the first social media account. The first order of priority may prioritize the overlap scores from a highest overlap score to a lowest overlap score.

### BACKGROUND

The present invention relates generally to the field of managing social media connections, and more particularly to prioritizing and recommending social media interactions using a Natural Language Processing (NLP) engine.

Today, social media interactions are usually limited to users creating profiles on social media platforms, making connections with other users on the social media platform based on suggestions made by the platforms, and sharing content among users within your network within that social media platform. However, suggestions made by the social media platforms are generally limited to already existing connections through employment, educational institutions, geographic location, and other static features.

Some social media platforms use a limited number of factors and filters to provide search results and determine relevancy of results using algorithms. Other social media platforms recommend network connections based on commonalities between the user and other users within the social media platform network based on contacts imported from address books and email addresses. Third-party published articles are also suggested as content for users within the social media platform to consume. For example, events advertised within a social media platform are monitored and the social media platforms determine the relevancy of those articles to the user based on a user's stated interests or activity within the social media platform.

### SUMMARY

The present invention is described in various embodiments disclosing computer-implemented methods, computer program products, and computer systems for prioritizing and recommending social media interactions. One embodiment of the present disclosure is a computer-implemented method for prioritizing and recommending social media interactions, wherein the computer-implemented method may include one or more processors configured for obtaining first profile data corresponding to a first social media account and additional profile data corresponding to additional social media accounts; determining a first unique identifier based on the first profile data and additional unique identifiers based on each respective additional profile data; determining overlap scores between the first unique identifier and each of the additional unique identifiers; prioritizing the additional social media accounts based on a first order of priority; and displaying the additional social media accounts based on the first order of priority on a user interface of a computing device associated with the first social media account. The first order of priority may prioritize the overlap scores from a highest overlap score to a lowest overlap score. The first profile data and the additional profile data may each comprise one or more profile data fields comprising at least one of profile information, status updates, posted content, event information, group information, message data, and site interaction activity.

In an embodiment, determining the first unique identifier may include configuring the one or more processors for extracting, using a natural language processing (NLP) engine, the first profile data from the one or more profile data fields; processing, using the NLP engine, the first profile data to output a first set of insights; and generating, using the NLP engine, a first fingerprint as a first collection of the first set of insights. Determining the additional unique identifiers may include configuring the one or more processors for extracting, using the NLP engine, the additional profile data from the one or more profile data fields; processing, using the NLP engine, the additional profile data to output additional sets of insights; and generating, using the NLP engine, additional fingerprints as additional collections of the additional sets of insights.

In an embodiment, determining the overlap scores may further include configuring the one or more processors for determining a degree of overlap between the first unique identifier and each of the additional unique identifiers based on a number of n-grams comparisons.

In another embodiment, the computer-implemented method may further include one or more processors configured for identifying the one or more profile data fields that were used in determining the overlap scores between the first unique identifier and the additional unique identifiers; and displaying the additional sets of insights corresponding to the one or more profile data fields used in determining the overlap scores with the associated social media accounts.

### BRIEF DESCRIPTION OF THE DRAWINGS

FIG. 1 depicts a block diagram of a distributed data processing environment for prioritizing and recommending social media interactions, in accordance with an embodiment of the present invention;

FIG. 2 depicts an example embodiment of the user interface for prioritizing and recommending social media interactions, in accordance with an embodiment of the present invention;

FIG. 3 depicts another example embodiment of the user interface for prioritizing and recommending social media interactions, in accordance with an embodiment of the present invention;

FIG. 4 depicts a block diagram of a system for prioritizing and recommending social media interactions, in accordance with an embodiment of the present invention;

FIG. 5 depicts a flow chart of steps of a computer-implemented method for prioritizing and recommending social media interactions, in accordance with an embodiment of the present invention; and

FIG. 6 depicts a block diagram of a computing device of the distributed data processing environment of FIG. 1, in accordance with an embodiment of the present invention.

### DETAILED DESCRIPTION

A solution is needed to prioritize and recommend social media interactions not based entirely on static parameters and factors, but rather considers the intersection between a user content fingerprint and the content fingerprints of other users.

The present invention addresses the problem of not being able to engage in meaningful and quality interactions within social media networks. It is very difficult to keep up with everything that everyone does on social platforms, and magically just know who to reach to, when, why, and about what. It is also a challenge to keep up with social connections constantly or kindling new connections. A person needs to know or be able to identify their common interests, activities, topics, and context that are valuable with every connection. Only once all that information has been identified and made available for use does the person have an opportunity for authentic interactions. In current processes, the person must know who or what they are searching for and also know their search query. For example, the search filters are based on exact keyword and Boolean matches, which need to be extensive in order to produce significant results. Once results are found by job title for example, the person must then tediously read through the results of the search including each connections profile, articles, and activity to make a decision on if the connection matches the person's request.

As an improvement, embodiments described herein identify insights and prioritize connection profiles based on the degree of commonality between A user and each connection. This allows a user to nurture existing connections and create authentic interactions based on relevant topics of commonality instead of creating static impersonalized connections. Further, embodiments described herein display a ranking of the social media account profiles based on a degree of commonality and also provide an explanation of the topics that produced the results. Embodiments described herein allow the user to access and interact with social media account profiles in a more authentic manner without having to manually troll the contents of the social media account profile, articles, and activity related to the user associated with the social media account that the user wishes to connect with.

Further, embodiments described herein may glean or extract insights that may be used to make recommendations that a user would not be able to know to look for using traditional methods like keyword or Boolean search.

The present invention is described in various embodiments disclosing computer-implemented methods, computer program products, and computer systems for prioritizing and recommending social media interactions. An embodiment of the present disclosure describes a computer-implemented method for prioritizing and recommending social media interactions, wherein the computer-implemented method may include one or more processors configured for obtaining first profile data corresponding to a first social media account and additional profile data corresponding to additional social media accounts. The first profile data and the additional profile data may each include one or more profile data fields (e.g., data sources) comprising at least one of profile information, status updates, posted content, event information, group information, message data, and site interaction activity. Profile data may also include other data fields corresponding to activity performed within the social media platform.

Profile data may be gathered by providing a user interface as part of a computing device to a user so that the user may interact with the user interface to provide the profile data. The profile data may be stored in a memory on the computing device or may be transmitted via a network to a database or server corresponding to a social media platform. The social media platform executing on a server may be configured to allow users to create social media accounts by receiving information about the user in particular profile data fields. For example, the social media account may include a profile data field corresponding to profile information to receive personal information (e.g., name, date of birth, email address, residence information, personal media content, etc.) about the user. The personal information may distinguish a particular user from other users or to allow users to be found within the social media platform using search features employing the personal information as search criteria.

In an embodiment, the one or more processors may be configured for determining a unique identifier based on the profile data and additional unique identifiers based on each respective additional profile data. For example, determining the unique identifier may include configuring the one or more processors for extracting, using a natural language processing (NLP) engine, the profile data from the one or more profile data fields. The unique identifier may be described as a fingerprint or an organized collection of the profile data.

In an embodiment, the one or more processors may be configured for processing, using the NLP engine, the profile data (e.g., unique identifier, fingerprint) to output a set of insights. For example, the set of insights may include concepts, keywords, taxonomies, and/or disambiguated word-senses.

In an embodiment, the NLP engine component may be a rules-based model configured to process unstructured text data to identify medical terminology and related concepts. The rules-based NLP engine component may be in the form of an Unstructured Information Management Architecture (UIMA), which may be configured to analyze large volumes of unstructured information in order to learn information that is relevant to the study. For example, the NLP engine component may be an UIMA application configured to analyze large volumes of unstructured information to discover and learn knowledge relevant to the study. The UIMA application may ingest plain text and identify entities, such as persons, places, and/or organizations; or relations, such as works-for or located-at.

In an embodiment, the one or more processors may be configured for generating a fingerprint as a collection of the set of insights. The fingerprint may include the organized collection of the profile data and/or the fingerprint determined using the profile data. Determining the additional unique identifiers may include configuring the one or more processors for extracting the additional profile data from the one or more profile data fields.

The one or more processors may be configured for processing, using the NLP engine, the additional profile data to output additional sets of insights. For example, information included in the profile data fields may be provided as an input to an NLP engine, wherein each profile data field may be provided as a vector input to the NLP engine. The NLP engine may be configured to process the profile data field vector inputs to generate a fingerprint as output data feature vectors. The output data feature vectors may be organized as the fingerprint for further processing.

In an embodiment, the one or more processors may be configured for processing, using the NLP engine, data corresponding to the fingerprint to extract all insights that can be gleaned from the fingerprint data. Thus, each fingerprint determined from each unique profile data may be a distinct collection of NLP insights. The one or more processors may be configured for generating additional fingerprints as additional collections of the additional sets of insights.

In an embodiment, the one or more processors may be configured for determining overlap scores between the first unique identifier and each of the additional unique identifiers. For example, the one or more processors may be configured to compare a first fingerprint with additional fingerprints to measure a degree of commonality between the first fingerprint and each of the additional fingerprints.

In an embodiment, the one or more processors may be configured to use automatic plagiarism detection to compare the first fingerprint to additional fingerprints to determine the degree of commonality between the first fingerprint and each one of the additional fingerprints. In an embodiment, the one or more processors may be configured to find original-plagiarized text pairs on the basis of flexible search strategies (i.e., able to detect plagiarized fragments even if they are modified from their source) using automatic plagiarism detection based on n-grams comparison. For example, if two (original and suspicious) text fragments are close enough, it can be assumed that they are a potential plagiarism case. A simpler implementation of the automatic plagiarism detection is to carry out a comparison of text chunks corresponding to the first fingerprint based on word-level n-grams. Thus, the degree of commonality may be determined between the degree of commonality of a first fingerprint with one or more of additional fingerprints. Further, the degree of commonality may be determined between the context by which the first fingerprint overlaps with one or more of the additional fingerprints and to generate an explanation of why the overlap occurred.

In an embodiment, the one or more processors may be configured for prioritizing the additional social media accounts based on a first order of priority. For example, responsive to the degree of commonality determined to be between the first fingerprint and one or more additional fingerprints, the one or more additional fingerprints may be organized in a prioritized list and presented as recommendations of who to reach out to and about what context insofar as to recent activities. This prioritized list allows for much more intelligent and personalized interaction with social media account profiles instead of tediously trawling the activity feeds of social media platforms manually.

The first order of priority may prioritize the overlap scores from a highest overlap score to a lowest overlap score. In an embodiment, determining the overlap scores may further include configuring the one or more processors for determining a degree of overlap between the first unique identifier and each of the additional unique identifiers based on a number of n-grams comparisons.

In an embodiment, the one or more processors may be configured for displaying the additional social media accounts based on the first order of priority on a user interface of a computing device associated with the first social media account.

In another embodiment, the computer-implemented method may further include one or more processors configured for identifying the one or more profile data fields that were used in determining the overlap scores between the first unique identifier and the additional unique identifiers; and displaying the additional sets of insights corresponding to the one or more profile data fields used in determining the overlap scores with the associated social media accounts.

The present invention will now be described in detail with reference to the Figures.

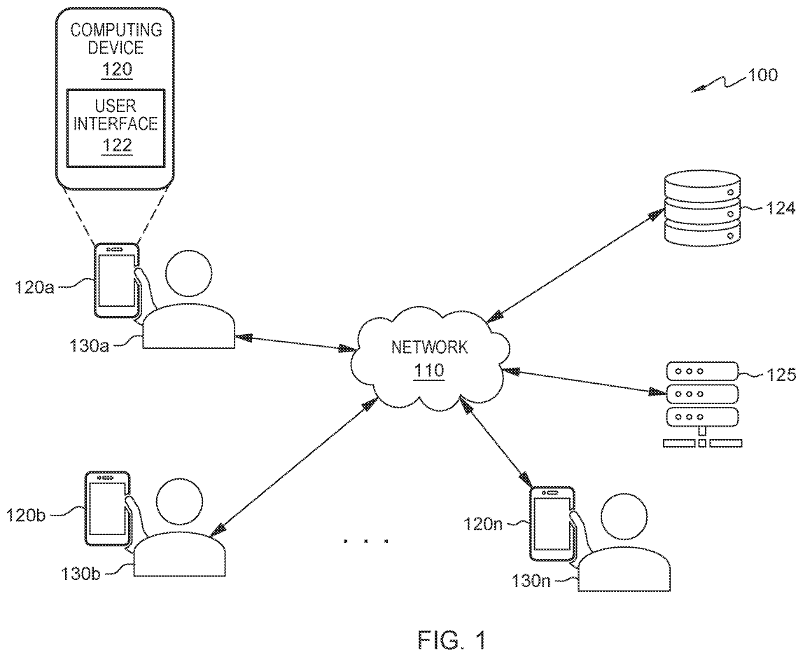

FIG. 1 depicts a block diagram of a distributed data processing environment for prioritizing and recommending social media interactions, in accordance with an embodiment of the present invention. FIG. 1 provides only an illustration of one embodiment of the present invention and does not imply any limitations with regard to the environments in which different embodiments may be implemented. In the depicted embodiment, distributed data processing environment 100 includes computing device 120a associated with a first user 130a, additional computing devices 120b . . . 120n associated with respective users 130b . . . 130n, server 125, and database 124, interconnected over network 110. Network 110 operates as a computing network that can be, for example, a local area network (LAN), a wide area network (WAN), or a combination of the two, and can include wired, wireless, or fiber optic connections. In general, network 110 can be any combination of connections and protocols that will support communications between computing device 120a, additional computing devices 120b . . . 120n, server 125, and database 124. Distributed data processing environment 100 may also include additional servers, computers, or other devices not shown.

Computing device 120a and additional computing devices 120b . . . 120n operate to execute at least a part of a computer program for prioritizing and recommending social media interactions. In an embodiment, computing device 120a and additional computing devices 120b . . . 120n may be configured to send and/or receive data from one or more of the other computing device(s) via network 110. Computing device 120a and additional computing devices 120b . . . 120n may each include a user interface 122 configured to facilitate interaction between user 130 and computing device 120. For example, user interface 122 may include a display as a mechanism to display data to a user and may be, for example, a touch screen, light emitting diode (LED) screen, or a liquid crystal display (LCD) screen. User interface 122 may also include a keypad or text entry device configured to receive alphanumeric entries from a user. User interface 122 may also include other peripheral components to further facilitate user interaction or data entry by user associated with respective computing device 120.

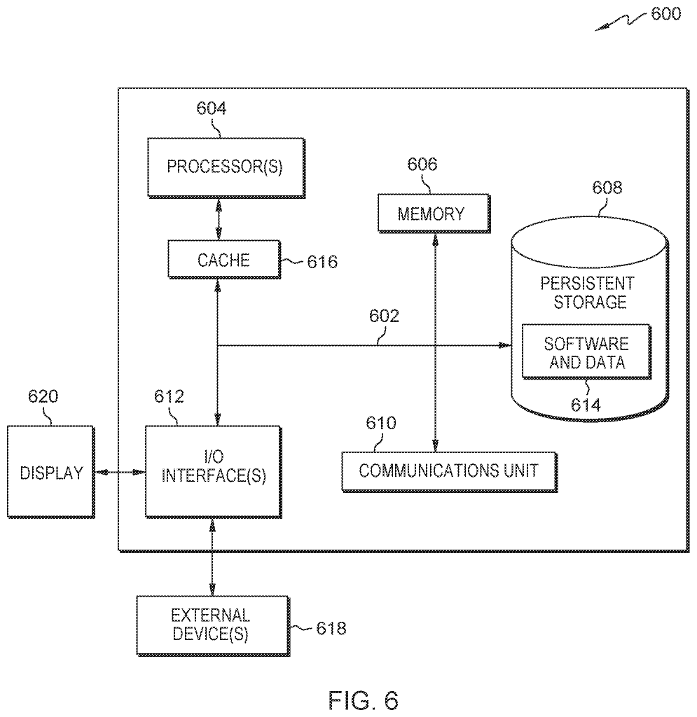

In some embodiments, computing device 120a and additional computing devices 120b . . . 120n may be a management server, a web server, or any other electronic device or computing system capable of receiving and sending data. In some embodiments, computing device 120a and additional computing devices 120b . . . 120n may be a laptop computer, tablet computer, netbook computer, personal computer (PC), a desktop computer, a smart phone, or any programmable electronic device capable of communicating with database 124, server 125 via network 110. Computing device 120a and additional computing devices 120b . . . 120n may include components as described in further detail in FIG. 6.

Computing device 120a and additional computing devices 120b . . . 120n may be configured to receive, store, and/or process images as image data captured on an image sensor. Computing device 120a and additional computing devices 120b . . . 120n may be configured to store the image data in memory or transmit the image data to database 124 and/or server 125 via network 110 for further storage and/or processing.

Database 124 operates as a repository for data flowing to and from network 110. Examples of data include profile data corresponding to data sources associated with a social media account created on a social media platform. A database is an organized collection of data. Database 124 can be implemented with any type of storage device capable of storing data and configuration files that can be accessed and utilized by computing device 120a and additional computing devices 120b . . . 120n, such as a database server, a hard disk drive, or a flash memory. In an embodiment, database 124 is accessed by computing device 120a and additional computing devices 120b . . . 120n to store data corresponding to creating a social media account on a social media platform, uploading media to a social media platform server, and interactions performed within the social media platform. In another embodiment, database 124 may reside elsewhere within distributed network environment 100 provided database 124 has access to network 110.

Server 125 can be a standalone computing device, a management server, a web server, or any other electronic device or computing system capable of receiving, sending, and processing data and capable of communicating with computing device 120a and additional computing devices 120b . . . 120n, and/or database 124 via network 110. In other embodiments, server 125 represents a server computing system utilizing multiple computers as a server system, such as a cloud computing environment. In yet other embodiments, server 125 represents a computing system utilizing clustered computers and components (e.g., database server computers, application server computers, etc.) that act as a single pool of seamless resources when accessed within distributed data processing environment 100. Server 125 may include components as described in further detail in FIG. 6.

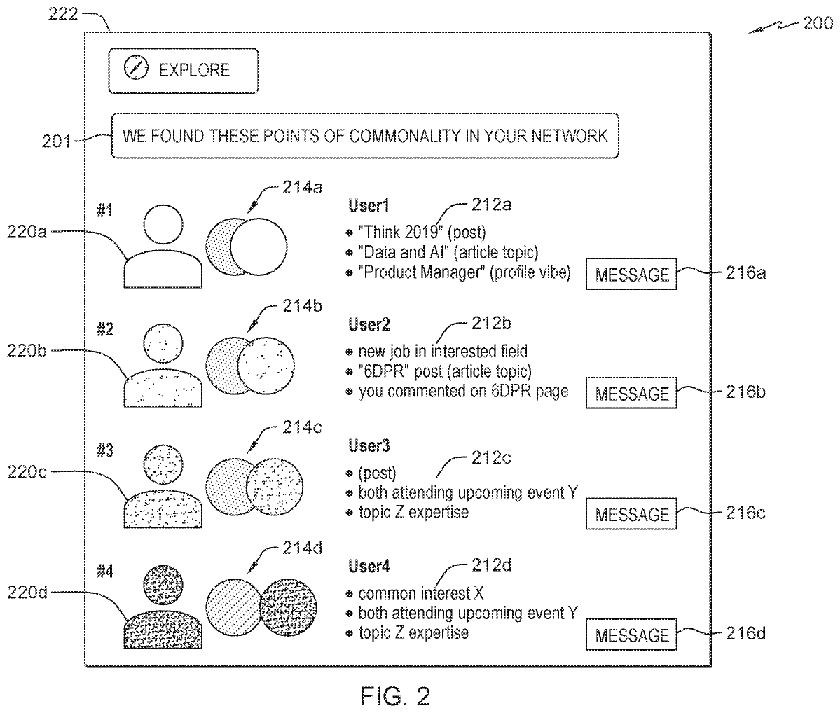

FIG. 2 depicts an example embodiment of the user interface 122 (e.g., shown as 222) for prioritizing and recommending social media interactions, in accordance with an embodiment of the present invention. In at least some embodiments, one or more processors may be configured to obtain first profile data corresponding to a first social media account and additional profile data corresponding to additional social media accounts. For example, social media platform 200 may enable data entry by a first user, which when entered and processed, generates first profile data. Thus, first profile data is collected for the first user to create the first social media account. The social media platform 200 may obtain additional profile data corresponding to additional social media accounts of users (e.g., 220a, 220b, 220c, 220d) different from the first user. The social media platform 200 may enable data entry by the additional users (e.g., 220a, 220b, 220c, 220d) similar to the first user. The one or more processors may be configured to perform data collection operations using application programming interfaces (APIs), web-scraping or screen-scraping techniques, or any other tools known to those of ordinary skill in the art.

The first profile data and the additional profile data may each include one or more profile data fields (e.g., data sources) comprising profile information, status updates, posted content, event information, group information, message data, and site interaction activity. Profile data may also include other data fields corresponding to activity performed within the social media platform.

In an embodiment, the one or more processors may be configured for converting the content of each profile (e.g., profile data) into a unique identifier (e.g., content fingerprint set) using NLP feature generation techniques. In other words, by converting the profile data into a unique identifier, a joint set of transformed text-based content that spans all the user data is generated. For example, the joint set features may include word n-grams (e.g., overlapping combinations of n words). Skipgrams could also be added to the feature set. For example, “The rain in Spain falls mainly on the plain” includes a set of 1-skip-2-grams that includes all the bigrams (2-grams), and in addition the sequences: “the in”, “rain Spain”, “in falls”, “Spain mainly”, “falls on”, “mainly the”, “and on plain”. Various other techniques can be used alone or in combination, like lemmatization, stemming, lowercasing, stop word removal, etc.

In an embodiment, the one or more processors may be configured for determining, using a NLP engine, a unique identifier based on the converted profile data and additional unique identifiers based on each respective converted additional profile data. For example, determining the unique identifier may include configuring the one or more processors for extracting the profile data from the one or more profile data fields, converting the extracted profile data and generating a unique identifier for each profile. The unique identifier may be described as a fingerprint or an organized collection of the profile data. The one or more processors may be configured to track which feature belongs to a particular item of content to present back to the user.

Once all the profile data available to the user in the social media platform is processed and corresponding fingerprints are determined for the user and the additional users (e.g., 220a, 220b, 220c, 220d), the one or more processors may be configured to generate user interface 122 displaying notification 201 indicating found points of commonality among contacts in the user's network. For example, social media accounts having the greatest points of commonality (e.g., 214a, 214b, 214c, 214d) in the first user's network may be displayed according to a first priority from most points of commonality to least points of commonality. Other orders of display may also be used depending on other factors determined by the user or by the social media platform.

In an embodiment, the one or more processors may be configured to arrange the content chronologically based on a time window (e.g., daily, weekly, monthly, quarterly, annually, etc.) to allow the user to determine network connections' activity that may be similar to the user's activity over a period of time or at a particular point in time.

The one or more processors may be configured for processing the additional profile data using the NLP engine to output additional sets of insights 212a-d. For example, information included in the profile data fields may be provided as an input to an NLP engine, wherein each profile data field may be provided as a vector input to the NLP engine. The NLP engine may be configured to process the profile data field vector inputs to generate a fingerprint as output data feature vectors. The output data feature vectors may be organized as the fingerprint for further processing. The one or more processors may be configured for processing data corresponding to the fingerprint using an NLP engine to extract all insights that can be gleaned from the fingerprint data. Thus, each fingerprint determined from each unique profile data may be a distinct collection of NLP insights 212. The one or more processors may be configured for generating additional fingerprints as additional collections of the additional sets of insights 212. For example, profile data associated with a social media account of the additional social media accounts may be processed by the NLP engine to determine a set of insights 212a corresponding to a post made (e.g., “Think 2019” event) on the social media platform, article topic engagement (e.g., liked “Data and AI” article), or a profile vibe (e.g., “Product Manager” job title).

In an embodiment, the one or more processors may be configured to generate a user selectable icon (e.g., messages 216a-d) configured to facilitate communications between the first user associated with the first social media account and one of the additional users of the additional social media accounts appearing in the search results. Upon selecting message 216 user-selectable icon, the one or more processors may be configured to generate a messaging dialog box to facilitate the communication.

In an embodiment, the one or more processors may be configured for determining overlap scores between the first unique identifier and each of the additional unique identifiers, wherein the overlap score may be displayed as overlapping icon 214 indicating a higher score proportional to the overlap. Overlapping icon 214 may include a first object (e.g., circle) representing a first user associated with the first social media account and a second object (e.g., circle) representing one of the additional users associated with one of the additional social media accounts, wherein the first object is visually distinguishable from the second object. The one or more processors may be configured to compare a first fingerprint with additional fingerprints to measure a degree of commonality between the first fingerprint and each of the additional fingerprints. For example, a first user may be compared to user1 220a, user2 220b, user3 220c, and user4 220d of the additional users corresponding to the additional social media accounts, wherein the additional social media accounts are arranged in an order of priority from most overlap to least overlap (e.g., 214a→214b→214c→214d).

In an embodiment, the one or more processors may be configured to determine the degree of commonality between the first fingerprint and each of the additional fingerprints using a containment equation or a resemblance equation. For example, let S(A) and S(B) be the set of trigrams from first profile data and one or more of the additional profile data respectively.

For the container equation C(A,B),

$$C = \frac{\vert S ( A ) ⋂ S ( B ) \vert}{\vert S ( B ) \vert} ,$$

if the extent to which set B is contained in set A is to be measured, then set A may be derived from concatenated first profile data extracted from the first profile and set B may be derived from concatenated one or more additional profile data from the first profile. Containment is the number of matches between the elements of trigram sets from A and B, scaled by the size of set B; in other words, the proportion of trigrams in B that are also in A.

For the resemblance equation R(A,B),

$$R = \frac{\vert S ( A ) ⋂ S ( B ) \vert}{\vert S ( A ) ⋃ S ( B ) \vert} ,$$

represents the number of matches between the elements of two sets of trigrams, scaled by joint set size. Thus, the output from either the containment equation or the resemblance equation is a specific overlap score between the user and each connection.

In an embodiment, the one or more processors may be configured to identify which connections (e.g., additional social media accounts) have notable commonality scores with the user (e.g., first social media account). Notable commonality scores may be determined using trend detection that identifies those connections that have notable larger degrees of commonality with the user than before (“the 2 users are trending in common”). Notable commonality scores may also be determined using short-term commonality, wherein the one or more processors may be configured to surface the top N most common connections, using the latest time-slice scores, in which N represents a pre-set number. Notable commonality scores may also be determined using long-term commonality, wherein the one or more processors may be configured to surface unique connections with the highest sustained commonality across all time periods.

In an embodiment, the one or more processors may be configured to identify which NLP features caused the high degree of overlap between the user (e.g., first social media account) and the top N identified connections (e.g., additional social media accounts) across any time horizon, in which N represents a pre-set number.

In an embodiment, the one or more processors may be configured to determine the associated content that mostly contributed to the highest degree of overlap between the user (e.g., first social media account) and the top N identified connections (e.g., additional social media accounts) and present (e.g., display) the associated content as the topics of interest (e.g., set of insights OR topics of interest) that the user can connect with the top N connections about, in which N represents a pre-set number.

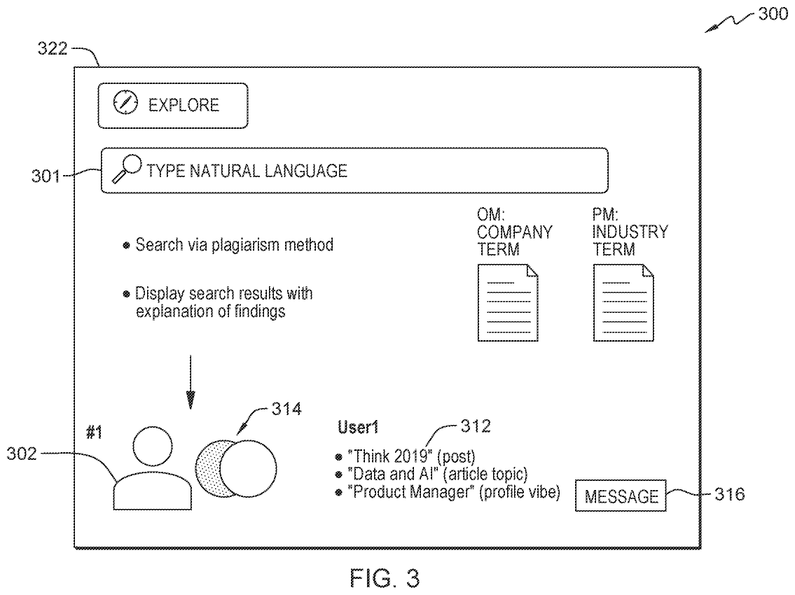

FIG. 3 depicts an example embodiment of the user interface 122 for prioritizing and recommending social media interactions, in accordance with an embodiment of the present invention. In an embodiment, user interface 122 (e.g., shown as 322) may be configured to generate search bar 301 configured to receive natural language entry (e.g., text, speech, and/or a document).

In an embodiment, the one or more processors may be configured to enable a user to perform a search using automatic plagiarism detection to identify a social media account associated with user 302 that matches a search string entered in search bar 301 displayed in user interface 122. For example, the one or more processors may be configured to receive a search string (e.g., text, speech, and/or a document) in search bar 301 and compare the search string to fingerprint data representing social media accounts within social media platform network 300. In performing the search, the one or more processors may be configured to determine the degree of commonality between the search string and the fingerprint data.

Once the search string is processed, the one or more processors may be configured to return and display search results with explanation of the search results. For example, if the search string is a document corresponding to profile data 312 (e.g., first profile data) extracted from a social media account (e.g., first social media account), wherein the profile data includes “OM: company term”, then the automatic plagiarism detection operation may return a result corresponding to one or more social media accounts (e.g., user1 302) that includes profile data (e.g., “PM: industry term”) including an explanation of why (e.g., “Think 2019 (post)”, “Data and AI (article topic)”, “Product Manager (vibe of profile). Here, user1 associated with social media account 302 was determined to have the highest degree of overlap (e.g., overlapping icon 314) between the search string and user1 302.

Further, the one or more processors may be configured to generate a user selectable icon (e.g., message 316) configured to facilitate communications between the first user associated with the first social media account and one of the additional users of the additional social media accounts (e.g., 302) appearing in the search results. Upon selecting message 316 user-selectable icon, the one or more processors may be configured to generate a messaging dialog box to facilitate the communication.

In an embodiment, the one or more processors may be configured to find original-plagiarized text pairs on the basis of flexible search strategies (i.e., able to detect plagiarized fragments even if they are modified from their source) using automatic plagiarism detection based on n-grams comparison. For example, if two (original [e.g., search string] and suspicious text fragments [e.g., fingerprints]) are close enough, it can be assumed that they are a potential plagiarism case (e.g., social media connection match). A simpler implementation of the automatic plagiarism detection is to carry out a comparison of text chunks corresponding to the search strong based on word-level n-grams. Thus, the degree of commonality may be determined between the degree of commonality of the search strong with one or more of additional fingerprints. Further, the degree of commonality may be determined between the context by which the search strong overlaps with one or more of the additional fingerprints and to generate an explanation of why the overlap occurred.

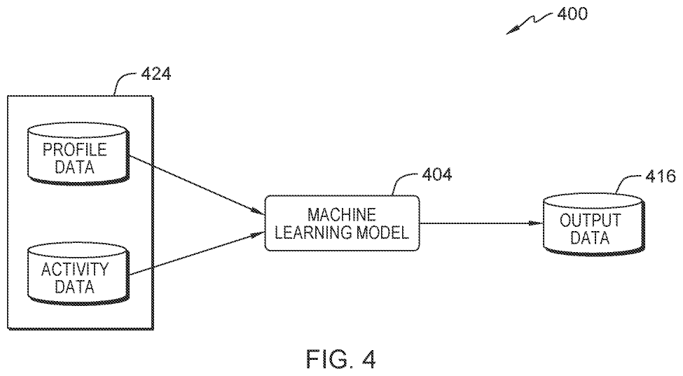

FIG. 4 depicts a block diagram of a system for prioritizing and recommending social media interactions, in accordance with an embodiment of the present invention. In the depicted embodiment, the system 400 may include a machine learning model 404 configured to receive profile data and activity data from database 424 to train machine learning model 404 and produce output data 416. Database 424 may include repositories for receiving and storing profile data and activity data to be sent upon request to machine learning model 404.

Various machine learning techniques may be used to train and operate trained components to perform various processes described herein. Models may be trained and operated according to various machine learning techniques. Such techniques may include, for example, neural networks (such as deep neural networks and/or recurrent neural networks), inference engines, trained classifiers, etc. Examples of trained classifiers include Support Vector Machines (SVMs), neural networks, decision trees, AdaBoost (short for “Adaptive Boosting”) combined with decision trees, and random forests. Focusing on SVM as an example, SVM is a supervised learning model with associated learning algorithms that analyze data and recognize patterns in the data, and which are commonly used for classification and regression analysis. Given a set of training examples, each marked as belonging to one of two categories, an SVM training algorithm builds a model that assigns new examples into one category or the other, making it a non-probabilistic binary linear classifier. More complex SVM models may be built with the training set identifying more than two categories, with the SVM determining which category is most similar to input data. An SVM model may be mapped so that the examples of the separate categories are divided by clear gaps. New examples are then mapped into that same space and predicted to belong to a category based on which side of the gaps they fall on. Classifiers may issue a “score” indicating which category the data most closely matches. The score may provide an indication of how closely the data matches the category.

In order to apply the machine learning techniques, the machine learning processes themselves need to be trained. Training a machine learning component requires establishing a “ground truth” for the training examples. In machine learning, the term “ground truth” refers to the accuracy of a training set's classification for supervised learning techniques. Various techniques may be used to train the models including backpropagation, statistical learning, supervised learning, semi-supervised learning, stochastic learning, or other known techniques.

The machine learning model 404 may be configured to receive multiple input data sets and produce model output data (e.g., output data 416) as feature vectors corresponding to each data set and transmit the model output data to a series of fully connected layers. The output data 416 from the fully connected layers may be representative of a recommendation for making a social media connection. This model output data may be in the form of a confidence score or probability for each resulting social media account representing the likelihood of receiving an acceptance of the user's request to connect.

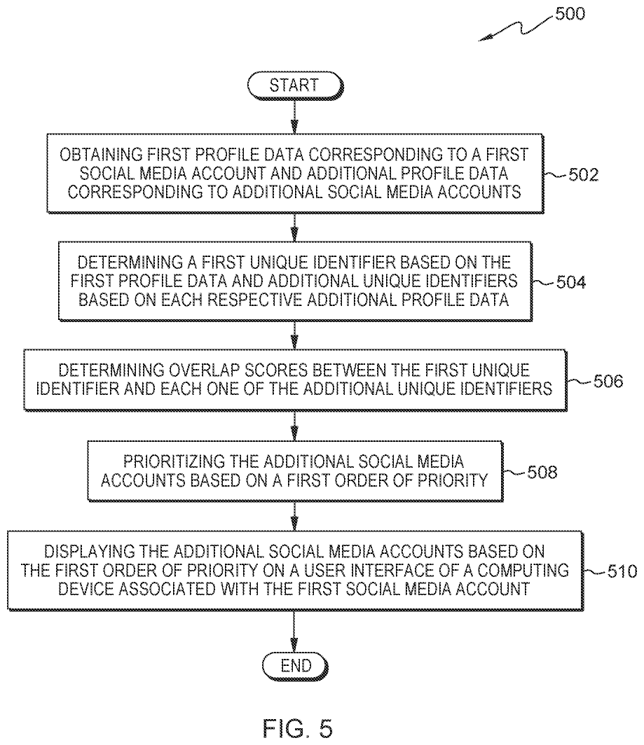

FIG. 5 depicts a flow chart of steps of a computer-implemented method 500 for prioritizing and recommending social media interactions, in accordance with an embodiment of the present invention.

In an embodiment, computer-implemented method 500 may include one or more processors configured to obtain 502 first profile data corresponding to a first social media account and additional profile data corresponding to additional social media accounts.

The first profile data and the additional profile data may each include one or more profile data fields (e.g., data sources) comprising profile information, status updates, posted content, event information, group information, message data, and site interaction activity. Profile data may also include other data fields corresponding to activity performed within the social media platform.

Profile data may be gathered by providing a user interface as part of a computing device to a user so that the user may interact with the user interface to provide the profile data. The profile data may be stored in a memory on the computing device or may be transmitted via a network to a database or server corresponding to a social media platform. The social media platform executing on a server may be configured to allow users to create social media accounts by receiving information about the user in particular profile data fields. For example, the social media account may include a profile data field corresponding to profile information to receive personal information (e.g., name, date of birth, email address, residence information, personal media content) about the user. The personal information may distinguish a particular user from other users or to allow users to be found within the social media platform using search features employing the personal information as search criteria.

In an embodiment, computer-implemented method 500 may include one or more processors configured to determine 504 a first unique identifier based on the first profile data and additional unique identifiers based on each respective additional profile data. For example, determining the unique identifier may include configuring the one or more processors for extracting the profile data from the one or more profile data fields. The unique identifier may be described as a fingerprint or an organized collection of the profile data.

In an embodiment, computer-implemented method 500 may include one or more processors configured to process the profile data (e.g., unique identifier, fingerprint) using a NLP engine to output a set of insights. For example, the set of insights may include concepts, keywords, taxonomies, disambiguated word-senses.

In an embodiment, computer-implemented method 500 may include one or more processors configured to determine 506 overlap scores between the first unique identifier and each of the additional unique identifiers. For example, the one or more processors may be configured to compare a first fingerprint with additional fingerprints to measure a degree of commonality between the first fingerprint and each of the additional fingerprints.

In an embodiment, computer-implemented method 500 may include one or more processors configured to prioritize 508 the additional social media accounts based on a first order of priority. For example, responsive to the degree of commonality is determined between the first fingerprint and one or more additional fingerprints, the one or more additional fingerprints may be organized in a prioritized list and presented as recommendations of who to reach out to, about what context insofar as to recent activities. This prioritized list allows for much more intelligent and personalized interaction with social media account profiles, instead of tediously trawling the activity feeds of social media platforms manually.

In an embodiment, computer-implemented method 500 may include one or more processors configured to display 510 the additional social media accounts based on the first order of priority on a user interface of a computing device associated with the first social media account.

FIG. 6 depicts a block diagram of computing device 600 suitable for server 125 and/or computing device 120, in accordance with an illustrative embodiment of the present invention. It should be appreciated that FIG. 6 provides only an illustration of one implementation and does not imply any limitations with regard to the environments in which different embodiments may be implemented. Many modifications to the depicted environment may be made.

Computing device 600 includes communications fabric 602, which provides communications between cache 616, memory 606, persistent storage 608, communications unit 610, and input/output (I/O) interface(s) 612. Communications fabric 602 can be implemented with any architecture designed for passing data and/or control information between processors (such as microprocessors, communications and network processors, etc.), system memory, peripheral devices, and any other hardware components within a system. For example, communications fabric 602 can be implemented with one or more buses or a crossbar switch.

Memory 606 and persistent storage 608 are computer readable storage media. In this embodiment, memory 606 includes random access memory (RAM). In general, memory 606 can include any suitable volatile or non-volatile computer readable storage media. Cache 616 is a fast memory that enhances the performance of computer processor(s) 604 by holding recently accessed data, and data near accessed data, from memory 606.

Programs may be stored in persistent storage 608 and in memory 606 for execution and/or access by one or more of the respective computer processors 604 via cache 616. In an embodiment, persistent storage 608 includes a magnetic hard disk drive. Alternatively, or in addition to a magnetic hard disk drive, persistent storage 608 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 608 may also be removable. For example, a removable hard drive may be used for persistent storage 608. Other examples include optical and magnetic disks, thumb drives, and smart cards that are inserted into a drive for transfer onto another computer readable storage medium that is also part of persistent storage 608.

Communications unit 610, in these examples, provides for communications with other data processing systems or devices. In these examples, communications unit 610 includes one or more network interface cards. Communications unit 610 may provide communications through the use of either or both physical and wireless communications links. Programs, as described herein, may be downloaded to persistent storage 608 through communications unit 610.

I/O interface(s) 612 allows for input and output of data with other devices that may be connected to server 125 and/or computing device 120. For example, I/O interface 612 may provide a connection to external devices 618 such as image sensor, a keyboard, a keypad, a touch screen, and/or some other suitable input device. External devices 618 can also include portable computer readable storage media such as, for example, thumb drives, portable optical or magnetic disks, and memory cards. Software and data 614 used to practice embodiments of the present invention can be stored on such portable computer readable storage media and can be loaded onto persistent storage 608 via I/O interface(s) 612. I/O interface(s) 612 also connect to a display 620.

Display 620 provides a mechanism to display data to a user and may be, for example, a computer monitor.

Software and data 614 described herein is identified based upon the application for which it is implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of computer-implemented methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method for prioritizing and recommending social media interactions, comprising:
obtaining, by one or more processors, first profile data corresponding to a first social media account and additional profile data corresponding to additional social media accounts;
determining, by the one or more processors, a first unique identifier based on the first profile data and additional unique identifiers based on each respective additional profile data;
determining, by the one or more processors, overlap scores between the first unique identifier and each of the additional unique identifiers;
prioritizing, by the one or more processors, the additional social media accounts based on a first order of priority; and
displaying, by the one or more processors, the additional social media accounts based on the first order of priority on a user interface of a computing device associated with the first social media account.

2. The computer-implemented method of claim 1, wherein the first order of priority prioritizes the overlap scores from a highest overlap score to a lowest overlap score.

3. The computer-implemented method of claim 1, wherein the first profile data and the additional profile data each comprise one or more profile data fields comprising at least one of profile information, status updates, posted content, event information, group information, message data, and site interaction activity.

4. The computer-implemented method of claim 3, wherein determining the first unique identifier further comprises:
extracting, using a natural language processing (NLP) engine, the first profile data from the one or more profile data fields;
processing, using the NLP engine, the first profile data to output a first set of insights; and
generating, using the NLP engine, a first fingerprint as a first collection of the first set of insights.

5. The computer-implemented method of claim 4, wherein determining the additional unique identifiers further comprises:
extracting, using the NLP engine, the additional profile data from the one or more profile data fields;
processing, using the NLP engine, the additional profile data to output additional sets of insights; and
generating, using the NLP engine, additional fingerprints as additional collections of the additional sets of insights.

6. The computer-implemented method of claim 1, wherein determining the overlap scores further comprises:
determining, by the one or more processors, a degree of overlap between the first unique identifier and each of the additional unique identifiers based on a number of n-grams comparisons.

7. The computer-implemented method of claim 5, further comprising:
identifying, by the one or more processors, the one or more profile data fields that were used in determining the overlap scores between the first unique identifier and the additional unique identifiers; and
displaying, by the one or more processors, the additional sets of insights corresponding to the one or more profile data fields used in determining the overlap scores with the associated additional social media accounts.

8. A computer program product for prioritizing and recommending social media interactions, the computer program product comprising:
one or more computer readable storage media and program instructions stored on the one or more computer readable storage media, the program instructions comprising:
program instructions to obtain first profile data corresponding to a first social media account and additional profile data corresponding to additional social media accounts;
program instructions to determine a first unique identifier based on the first profile data and additional unique identifiers based on each respective additional profile data;
program instructions to determine overlap scores between the first unique identifier and each of the additional unique identifiers;
program instructions to prioritize the additional social media accounts based on a first order of priority; and
program instructions to display the additional social media accounts based on the first order of priority on a user interface of a computing device associated with the first social media account.

9. The computer program product of claim 8, wherein the first order of priority prioritizes the overlap scores from a highest overlap score to a lowest overlap score.

10. The computer program product of claim 8, wherein the first profile data and the additional profile data each comprise one or more profile data fields comprising at least one of profile information, status updates, posted content, event information, group information, message data, and site interaction activity.

11. The computer program product of claim 10, wherein the program instructions to determine the first unique identifier further comprises:
program instructions to extract, using a natural language processing (NLP) engine, the first profile data from the one or more profile data fields;
program instructions to process, using the NLP engine, the first profile data to output a first set of insights; and
program instructions to generate, using the NLP engine, a first fingerprint as a first collection of the first set of insights.

12. The computer program product of claim 11, wherein the program instructions to determine the additional unique identifiers further comprises:
program instructions to extract, using the NLP engine, the additional profile data from the one or more profile data fields;
program instructions to process, using the NLP engine, the additional profile data using the natural language processing (NLP) engine to output additional sets of insights; and
program instructions to generate, using the NLP engine, additional fingerprints as additional collections of the additional sets of insights.

13. The computer program product of claim 8, wherein the program instructions to determine the overlap scores further comprises:
program instructions to determine a degree of overlap between the first unique identifier and each of the additional unique identifiers based on a number of n-grams comparisons.

14. The computer program product of claim 12, further comprising:
program instructions to identify the one or more profile data fields that were used in determining the overlap scores between the first unique identifier and the additional unique identifiers; and
program instructions to display the additional sets of insights corresponding to the one or more profile data fields used in determining the overlap scores with the associated additional social media accounts.

15. A computer system for prioritizing and recommending social media interactions, the computer system comprising:
one or more computer processors;
one or more computer readable storage media;
program instructions stored on the one or more computer readable storage media for execution by at least one of the one or more processors, the program instructions comprising:
program instructions to obtain first profile data corresponding to a first social media account and additional profile data corresponding to additional social media accounts;
program instructions to determine a first unique identifier based on the first profile data and additional unique identifiers based on each respective additional profile data;
program instructions to determine overlap scores between the first unique identifier and each of the additional unique identifiers;
program instructions to prioritize the additional social media accounts based on a first order of priority; and
program instructions to display the additional social media accounts based on the first order of priority on a user interface of a computing device associated with the first social media account.

16. The computer system of claim 15, wherein the first profile data and the additional profile data each comprise one or more profile data fields comprising at least one of profile information, status updates, posted content, event information, group information, message data, and site interaction activity, wherein the first order of priority prioritizes the overlap scores from a highest overlap score to a lowest overlap score.

17. The computer system of claim 16, wherein the program instructions to determine the first unique identifier further comprises:
program instructions to extract, using a natural language processing (NLP) engine, the first profile data from the one or more profile data fields;
program instructions to process, using the NLP engine, the first profile data to output a first set of insights; and
program instructions to generate, using the NLP engine, a first fingerprint as a first collection of the first set of insights.

18. The computer system of claim 17, wherein the program instructions to determine the additional unique identifiers further comprises:
program instructions to extract, using the NLP engine, the additional profile data from the one or more profile data fields;
program instructions to process, using the NLP engine, the additional profile data to output additional sets of insights; and
program instructions to generate, using the NLP engine, additional fingerprints as additional collections of the additional sets of insights.

19. The computer system of claim 15, wherein the program instructions to determine the overlap scores further comprises:
program instructions to determine a degree of overlap between the first unique identifier and each of the additional unique identifiers based on a number of n-grams comparisons.

20. The computer system of claim 18, further comprising:
program instructions to identify the one or more profile data fields that were used in determining the overlap scores between the first unique identifier and the additional unique identifiers; and
program instructions to display the additional sets of insights corresponding to the one or more profile data fields used in determining the overlap scores with the associated additional social media accounts.
